(19) United States
(12) Patent Application Publication
(10) Pub. No.: US 2020/0168225 A1
(43) Pub. Date: May 28, 2020

(54) INFORMATION PROCESSING APPARATUS AND INFORMATION PROCESSING METHOD

(71) Applicant: SHARP KABUSHIKI KAISHA, Sakai City (JP)

(72) Inventor: AKIRA WATANABE, Sakai City (JP)

(21) Appl. No.: 16/694,473

(22) Filed: Nov. 25, 2019

(30) Foreign Application Priority Data
Nov. 26, 2018 (JP) 2018-220547

(51) Int. Cl. G10L 15/22; G10L 15/26

(52) U.S. Cl. CPC G10L 15/222; G10L 2015/223; G10L 15/265

(57) ABSTRACT

A server includes a communication unit and a controller. In the server, the controller projects urgency felt by a user and performs switching of a text of a response to the user based on the projected urgency if speech of the user is acquired via the communication unit while a terminal is uttering an utterance text. The urgency is projected based on the start time of the speech of the user.

### BACKGROUND

### 1. Field

The present disclosure relates to an information processing apparatus and an information processing method.

### 2. Description of the Related Art

Speech interaction systems proceed with interaction in such a manner that the system and a user alternately give utterance. The speech interaction systems are used for various systems such as a guidance system, a receiving system, and a small-talk system. Japanese Unexamined Patent Application Publication No. 2014-038150 (published on Feb. 27, 2014) and Japanese Unexamined Patent Application Publication No. 2018-054791 (published on Apr. 5, 2018) are examples of the related art.

Such interaction systems give priority to utterance that is easy for a user to listen and thus utter slowly. In addition, for correct operations, utterance for verifying the content of utterance by the user is given during the interaction, and thus the interaction often proceeds slowly. However, for example, when using a guidance, the user may be pressed for time, and the interaction speed does not match the feeling of the user in some cases.

It is desirable to implement utterance appropriate for urgency felt by a user in an aspect of the present disclosure.

### SUMMARY

According to an aspect of the disclosure, there is provided an information processing apparatus including a speech-information acquisition unit and a controller. The controller projects urgency felt by a user and performing switching of a text of a response to the user based on the projected urgency if speech of the user is acquired via the speech-information acquisition unit while the information processing apparatus or a different apparatus is uttering an utterance text. The urgency is projected based on a start time of the speech of the user.

According to an aspect of the disclosure, there is provided an information processing method performed by an information processing apparatus. The method includes projecting urgency felt by a user and performing switching of a text of a response to the user based on the projected urgency if speech of the user is acquired while the information processing apparatus or a different apparatus is uttering an utterance text. The urgency is projected based on a start time of the speech of the user.

### Advantageous Effects of Invention

An aspect of the disclosure advantageously desires to implement utterance appropriate for urgency felt by a user in an aspect of the present disclosure.

### BRIEF DESCRIPTION OF THE DRAWINGS

FIG. 1 is a diagram illustrating the configuration of an interaction system according to Embodiment 1 of the present disclosure;

FIG. 2 is a block diagram illustrating the configuration of a terminal according to Embodiment 1 of the present disclosure;

FIG. 3 is a block diagram illustrating the configuration of a server according to Embodiment 1 of the present disclosure;

FIG. 4 is a diagram for explaining barge-in information according to Embodiment 1 of the present disclosure;

FIG. 5 is a table illustrating an example structure of a response decision DB according to Embodiment 1 of the present disclosure;

FIG. 6 is a table illustrating an example structure of a response text DB according to Embodiment 1 of the present disclosure;

FIG. 7 is a table illustrating an example structure of the response decision DB according to Embodiment 1 of the present disclosure;

FIG. 8 is a table illustrating an example structure of the response text DB according to Embodiment 1 of the present disclosure;

FIG. 9 is a flowchart illustrating a process by the interaction system according to Embodiment 1 of the present disclosure; and

FIG. 10 is a block diagram illustrating the configuration of a computer usable as the terminal or the server according to Embodiment 3 of the present disclosure.

### DESCRIPTION OF THE EMBODIMENTS

### Embodiment 1

Hereinafter, Embodiment 1 of the present disclosure will be described in detail. An interaction system 1 according to this embodiment uses a mechanism allowing barge in (an event in which a user barges in and utters while a system is being uttering). The interaction system 1 changes a system response (such as the text or the length of speech or an utterance speed) based on whether a barge in occurs or on the occurrence time.

For example, if a barge in does not occur, the interaction system 1 politely verifies the content of utterance by the user. In contrast, if a barge in occurs, the interaction system 1 does not verify the content of utterance by the user or makes a verification speech shorter.

Accordingly, the conversation speed may be changed depending on the personality or a feeling of the user, and thus user-friendliness may be enhanced.

### Interaction System 1

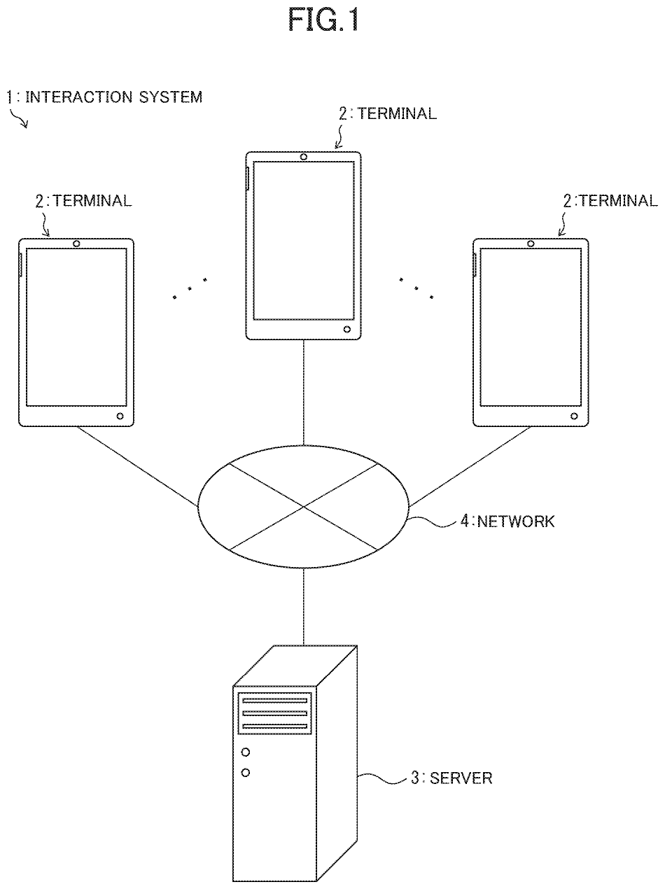

FIG. 1 is a diagram illustrating the configuration of the interaction system 1 according to this embodiment. The interaction system 1 is a system that performs speech interaction with the user. As illustrated in FIG. 1, the interaction system 1 includes a plurality of terminals 2 and a server 3. Each terminal 2 and the server 3 are configured to enable communications via a network 4. The terminal 2 is a terminal held by a user and serving as an interaction counterpart and is composed of, for example, a personal computer (PC), a smartphone, or a tablet terminal. The server 3 is a server for implementing the interaction system 1 in such a manner as to communicate with the terminal 2 and is composed of a server computer or the like. The network 4 is a communication network such as a local area network (LAN) or the Internet.

### Terminal 2

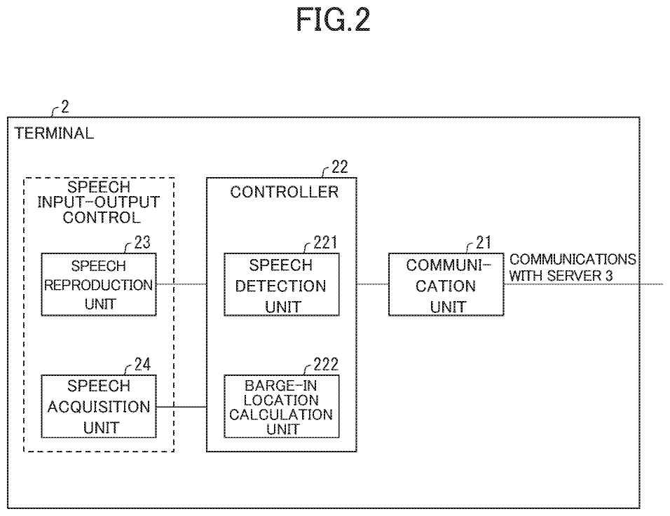

FIG. 2 is a block diagram illustrating the configuration of the terminal 2 according to this embodiment. As illustrated in FIG. 2, the terminal 2 includes, as hardware, a communication unit 21, a controller 22, a speech reproduction unit 23, and a speech acquisition unit 24.

The communication unit 21 is connected to the network 4 and communicates with the server 3 via the network 4.

The controller 22 performs overall control of the terminal 2. As illustrated in FIG. 2, the controller 22 functions as a speech detection unit 221 and a barge-in location calculation unit 222 and is composed of, for example, a central processing unit (CPU). The speech detection unit 221 determines whether the user is inputting speech into the terminal 2. The barge-in location calculation unit 222 decides barge-in information indicating a state where the speech of the user barges in while the terminal 2 is being uttering (hereinafter, also referred to as a “system utterance”).

The speech reproduction unit 23 and the speech acquisition unit 24 control speech input and output. The speech reproduction unit 23 utters to the user and is composed of, for example, a speaker. The speech acquisition unit 24 acquires the speech of the user and is composed of, for example, a microphone.

### Server 3

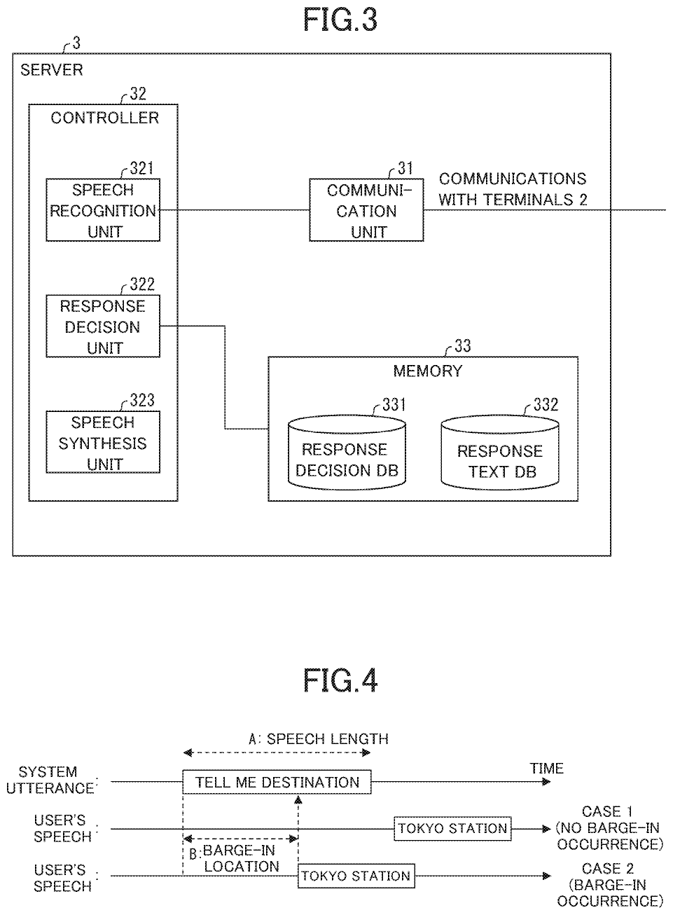

FIG. 3 is a block diagram illustrating the configuration of the server 3 according to this embodiment. As illustrated in FIG. 3, the server (an information processing apparatus) 3 includes, as hardware, a communication unit (speech-information acquisition unit) 31, a controller 32, and a memory 33.

The communication unit 31 is connected to the network 4 and communicates with the terminal 2 via the network 4.

The controller 32 performs overall control of the server 3. In particular, if the speech of the user is acquired via the communication unit 31 while the terminal (a different apparatus) 2 is uttering an utterance text, the controller 32 projects urgency felt by the user based on the start time of the speech of the user and performs switching of the text of a response to the user based on the projected urgency.

Since the urgency felt by the user is projected based on the start time of the speech of the user during the utterance by the terminal 2 and switching is performed of the response text based on the urgency, utterance based on the urgency felt by the user may be implemented.

As illustrated in FIG. 3, the controller 32 functions as a speech recognition unit 321, a response decision unit 322, and a speech synthesis unit 323 and is composed of, for example, a CPU.

The speech recognition unit 321 converts data regarding the user's speech received from the terminal 2 into text data. The response decision unit 322 decides text data for utterance by the terminal 2 based on the text data regarding the user's speech converted by the speech recognition unit 321 and on the barge-in information received from the terminal 2. The speech synthesis unit 323 converts the text data decided by the response decision unit 322 into speech data.

The memory 33 stores therein data in accordance with an instruction from the controller 32 and also reads out the data. The memory 33 is composed of a nonvolatile recording medium such as a hard disk drive (HDD) or a solid state drive (SSD). In the memory 33, a response decision database (DB) 331 and a response text DB 332 are constructed as databases and stored. The response decision DB 331 is a DB for deciding the next response based on the speech of the user. The response text DB 332 is a DB for storing a text of a response to the speech of the user.

Note that the terminal 2 may execute the above-described processes by the server 3. In this case, the terminal (an information processing apparatus) 2 according to this embodiment includes the speech acquisition unit (a speech-information acquisition unit) 24 and the controller 22. If the speech of the user is acquired via the speech acquisition unit 24 while the terminal (information processing apparatus) 2 is uttering an utterance text, the controller 22 projects urgency felt by the user based on the start time of the speech of the user and performs switching of the text of the response to the user based on the projected urgency.

Specifically, in a case where the information processing apparatus is implemented as the server 3, the speech-information acquisition unit according to an aspect of the present disclosure does not denote a microphone but an interface that acquires a speech signal. In contrast, it can be said that in a case where the information processing apparatus is implemented as the terminal 2, the speech-information acquisition unit is a microphone.

### Barge-In Information

FIG. 4 is a diagram for explaining the barge-in information according to this embodiment. The barge-in information includes a barge-in percentage and a barge-in location. The horizontal axis of FIG. 4 is a time axis.

In the server 3 according to this embodiment, the controller 32 may also project the urgency felt by the user based on a barge-in percentage. Since a barge-in percentage at the time of barging in of the speech of the user on utterance by the apparatus is used as a response switching condition, an intuitive condition setting may be achieved.

The barge-in percentage represents the percentage of the completed part of the system utterance at the time of occurrence of the barging in of the speech of the user (that is, the proportion of the amount of a text that is uttered in the utterance text at the start time of the speech of the user to the amount of the entirety of the utterance text.

The amount of the text may correspond to the temporal length or the number of characters of the uttered text. The amount of the entirety of the utterance text may correspond to the temporal length or the number of characters of the entirety of the utterance text.

The barge-in percentage is calculated in accordance with the following Formula 1.

The barge-in percentage=(barge-in location/speech length)×100% Formula 1

The speech length represents the amount of the entirety of the system utterance and is denoted by reference A in FIG. 4. The barge-in location represents the amount of uttered system utterance at the start of the speech of the user and is denoted by reference B in FIG. 4. In Case 1 in FIG. 4, that is, in the case of A<B, a barge in does not occur, and the barge-in percentage is 100%.

In the server 3 according to this embodiment, the controller 32 may also project the urgency felt by the user based on the barge-in location. Since a barge-in location at the time of barging in of the speech of the user on utterance by the apparatus is used as a response switching condition, an intuitive condition setting with the boundary in the utterance text being designated accurately may be achieved.

The barge-in location represents time corresponding to the number of seconds from the start of the system utterance to the start of the speech of the user (that is, the amount of a text that is uttered in the utterance text at the start time of the speech of the user) and is denoted by reference B in FIG. 4. Note that the terminal 2 does not receive the input of the speech of the user before the start of the system utterance.

The amount of the text may correspond to the temporal length or the number of characters of the uttered text.

### Response Decision DB 331

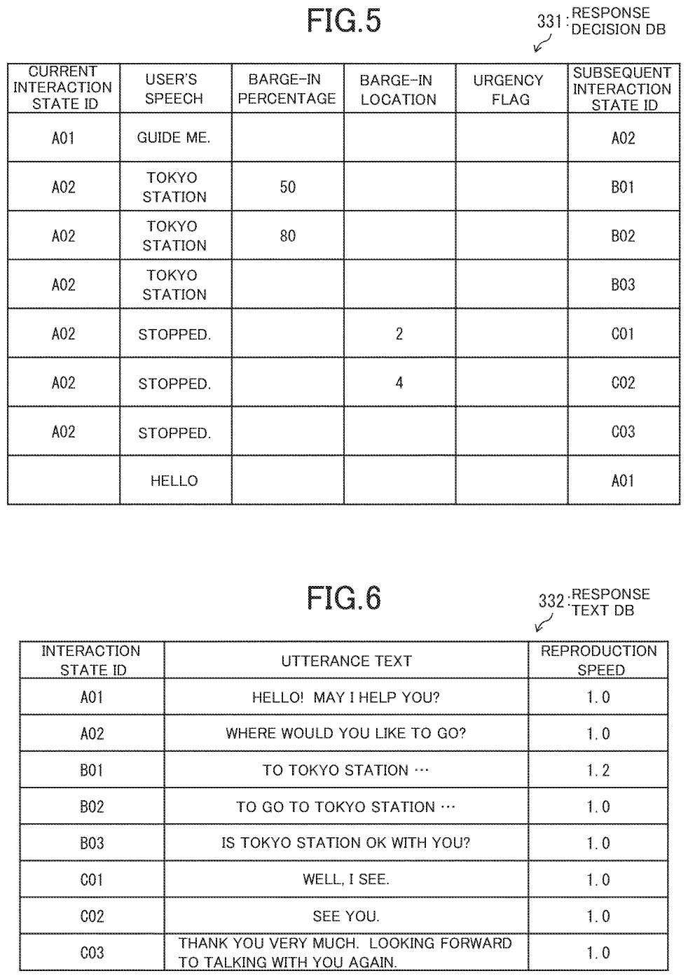

FIG. 5 is a table illustrating an example structure of the response decision DB 331 according to this embodiment. As illustrated in FIG. 5, the response decision DB 331 has a plurality of records including a current interaction state identification (ID), speech of the user, a barge-in percentage, a barge-in location, an urgency flag, and a subsequent interaction state ID. The current interaction state ID is an interaction state ID associated with an utterance text of the preceding response (see FIG. 6). The speech of the user is a text converted from speech acquired from the user through speech recognition. The barge-in percentage and the barge-in location have been described with reference to FIG. 4. The urgency flag will be described later. The subsequent interaction state ID is used to designate one of the interaction state IDs in the response text DB 332.

The response decision unit 322 of the server 3 performs a condition search on the response decision DB 331 by using, as keys, the speech of the user and one of the barge-in percentage and the barge-in location and thereby decides a subsequent interaction state ID. Rules for the condition search are described below.

Rule R1: The response decision unit 322 performs determination in order from the first row (record) in the response decision DB 331. If the keys match the condition, the response decision unit 322 terminates the condition search.
Rule R2: If perfect matching applies to a current interaction state ID and speech of the user, the matching is determined as True.
Rule R3: If DB values of a current interaction state ID and speech of the user are null, a wildcard is used as the keys. Rule R4: If acquired value <=DB value holds true for the barge-in percentage and the barge-in location, the matching is determined as True.
Rule R5: One of the barge-in percentage and the barge-in location is set in the response decision DB 331. Accordingly, the response decision unit 322 performs condition evaluation on the set one and projects urgency felt by the user. If both of the barge-in percentage and the barge-in location are not set, a wildcard is used.

For example, if the current interaction state ID is A02, if the speech of the user is Tokyo Station, and if the barge-in percentage is 60%, the keys match the values in the third row in FIG. 5. The response decision unit 322 thus decides B02 as the subsequent interaction state ID.

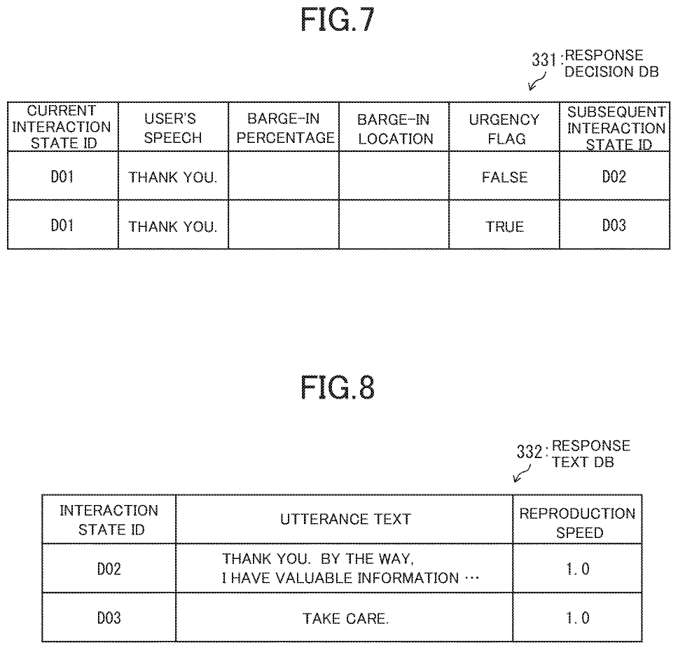

For the handling of the urgency flag, refer to the explanation with reference to FIG. 7. As illustrated in FIG. 5, if the field for the urgency flag is empty, the wildcard is used.

### Response Text DB 332

FIG. 6 is a table illustrating an example structure of the response text DB 332 according to this embodiment. As illustrated in FIG. 6, the response text DB 332 has a plurality of records including an interaction state ID, an utterance text, and a reproduction speed.

The interaction state ID is an ID corresponding to a subsequent interaction state ID in the response decision DB 331. That is, each record of the response text DB 332 is associated with a corresponding one of the records in the response decision DB 331 by using an interaction state ID. The utterance text is an utterance text to be replied by the terminal 2 in response to the speech of the user. Regarding the reproduction speed, 1.0 is set as a normal speed. A value larger than 1.0 is set as a speed higher than the normal speed, and a value smaller than 1.0 is set as a speed lower than the normal speed.

A response associated with an interaction state ID will hereinafter be described. A response associated with B01 is a guidance given fast and briefly when the user asks a direction in a hurry. A response associated with B02 is a guidance given briefly when the user asks a direction slightly in a hurry. A response associated with B03 is a guidance given politely when the user asks a direction calmly. A response associated with C01 is a reply made in a sulky mood when the user discontinues the conversation in a hurry. A response associated with C02 is a reply made ordinarily when the user discontinues the conversation slightly in a hurry. A response associated with C03 is a reply made politely when the user discontinues the conversation calmly.

The response decision unit 322 of the server 3 refers to the response text DB 332 and thereby decides a response text in accordance with the decided subsequent interaction state ID. Based on the response text decided by the response decision unit 322, the speech synthesis unit 323 synthesizes speech data to be transmitted to the terminal 2. Note that a change in the utterance may be a change in the speech, the utterance speed, or the scenario. In the scenario change, for example, verifying is interposed between speeches, and a completely different interaction is subsequently performed.

For example, if the response decision unit 322 decides B01 as a subsequent interaction state ID in the response decision DB 331, the response decision unit 322 refers to the response text DB 332 and thereby decides “To Tokyo Station” as an utterance text and 1.2 as a reproduction speed. The speech synthesis unit 323 synthesizes speech data from the utterance text “To Tokyo Station” and the reproduction speed of 1.2.

### Urgency Flag

In the server 3 according to this embodiment, the controller 32 may also switch the length of a response statement, the utterance speed, or the number of response statements in the text of the response to the user based on the urgency. Since the length of the statement of the response to the user, the utterance speed, or the number of response statements is switched, the time length of the response text may be controlled based on the urgency felt by the user.

FIG. 7 is a table illustrating an example structure of the response decision DB 331 according to this embodiment. FIG. 8 is a table illustrating an example structure of the response text DB 332 according to this embodiment.

As illustrated in FIG. 7, the response decision DB 331 has records including the urgency flag.

The urgency flag is provided to switch utterance by the interaction system 1 in such a manner that whether the user is in a hurry is judged through the entire interaction performed by several utterance reciprocations and that True or False is set in accordance with the judgment result.

Urgency flag handling will hereinafter be described. First, False is initially set in the urgency flag at the start of the system (at the start of the interaction). Every time the user utters, the controller 32 of the server 3 refers to the barge-in percentage and updates the urgency flag. If the barge-in percentage is lower than or equal to a threshold set in advance (for example, 90%), the controller 32 sets True as the urgency flag. That is, the controller 32 projects the urgency felt by the user based on the start time of the speech of the user. Once the controller 32 sets True as the urgency flag, the controller 32 does not set False thereafter. Note that any value is settable as the above-described threshold on a per interaction system 1 basis.

If a DB value for the urgency flag is null, the wildcard is used. For example, the urgency flags in the response decision DB 331 in FIG. 5 all have a null value, and thus this means that the urgency flags are not taken into consideration.

The server 3 according to this embodiment judges whether the user is in a hurry through the conversation, with the response decision DB 331 being set as illustrated in FIG. 7. If the user is not in a hurry (low urgency), the number of response statements in the text of the response to the user may be increased. Since the number of response statements to the user is increased when the urgency felt by the user is low, utterance for a small talk, an advertisement, or the like may be given after the end of the conversation.

A response associated with an interaction state ID will hereinafter be described with reference to FIG. 8. A response associated with D02 is a response in which the user is judged not to be in a hurry and an advertisement is started. A response associated with D03 is a response in which the user is likely to be in a hurry, and thus utterance is given briefly and then terminated.

### Process by Interaction System 1

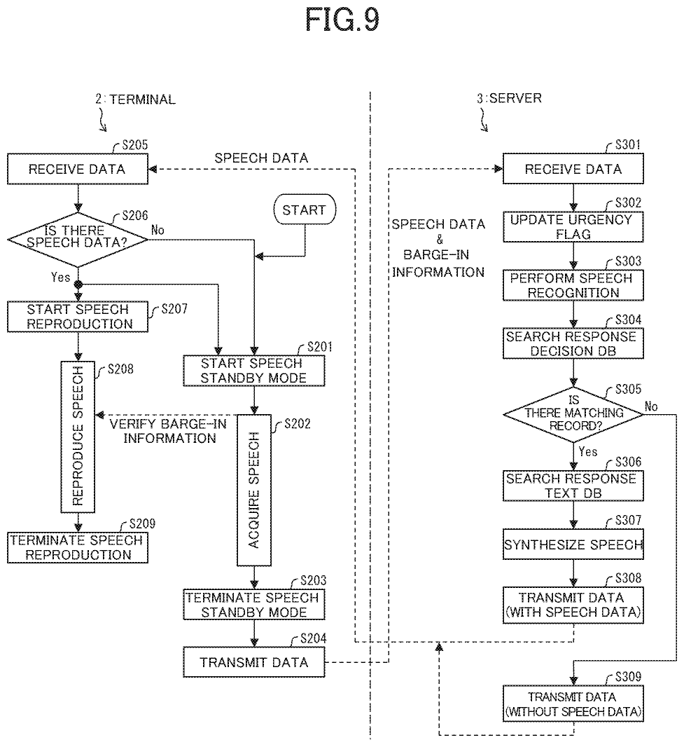

FIG. 9 is a flowchart illustrating a process by the interaction system 1 according to this embodiment. Hereinafter, a process by the terminal 2 (steps S201 to S209), a process by the server 3 (steps S301 to S309), and data exchanged therebetween will be described with reference to FIG. 9.

### Step S201

In the terminal 2, the controller 22 starts a speech standby mode. For example, when the terminal 2 starts a predetermined service application (such as a guidance application) in accordance with the user's operation, the controller 22 starts the speech standby mode.

### Step S202

The speech acquisition unit 24 acquires the speech of the user. In this case, when the speech acquisition is started, the barge-in location calculation unit 222 acquires data indicating the progress of speech reproduction in step S208 from the speech reproduction unit 23.

### Step S203

The speech detection unit 221 of the controller 22 determines whether the user is inputting speech into the terminal 2. If the user is inputting speech into the terminal 2, the controller 22 causes the speech acquisition unit 24 to continue the speech acquisition. If the user is not inputting speech into the terminal 2, the controller 22 terminates the speech standby mode.

### Step S204

From the data acquired in step S202, the barge-in location calculation unit 222 generates barge-in information indicating a state where the speech of the user barges in on utterance by the terminal 2. The controller 22 transmits the user's speech data and the barge-in information to the server 3 via the communication unit 21.

### Step S301

In the server 3, the controller 32 receives the user's speech data and the barge-in information from the terminal 2 via the communication unit 31.

### Step S302

If the barge-in percentage or the barge-in location in the barge-in information is lower than or equal to the threshold set in advance, the controller 32 updates the urgency flag with True.

### Step S303

The speech recognition unit 321 converts the user's speech data received from the terminal 2 into text data, that is, performs speech recognition.

### Step S304

The response decision unit 322 performs a condition search on the response decision DB 331 by using, as keys, the text of the user's speech acquired by the speech recognition unit 321 and the barge-in information received from the terminal 2.

### Step S305

The response decision unit 322 determines whether there is a record matching the keys in the response decision DB 331. If there is a record matching the keys (YES in step S305), the response decision unit 322 performs step S306. If there is not a record matching the keys (NO in step S305), the controller 32 performs step S309.

### Step S306: Switching Text of Response to User

The response decision unit 322 searches the response text DB 332 by using, as a key, the subsequent interaction state ID of the record matching the keys and decides an utterance text and a reproduction speed, that is, decides a response text to be uttered by the terminal 2.

### Step S307

From the utterance text and the reproduction speed decided by the response decision unit 322, the speech synthesis unit 323 synthesizes data regarding speech to be uttered by the terminal 2. Specifically, the speech synthesis unit 323 converts the text data decided by the response decision unit 322 into speech data.

### Step S308

The controller 32 transmits the speech data synthesized by the speech synthesis unit 323 to the terminal 2 via the communication unit 31.

### Step S309

The controller 32 transmits data indicating no speech data to the terminal 2 via the communication unit 31.

### Step S205

In the terminal 2, the controller 22 receives the data from the server 3 via the communication unit 21.

### Step S206

The controller 22 determines whether there is speech data in the received data. If there is speech data in the received data (YES in step S206), the controller 22 performs steps S201 and S207. If there is not speech data in the received data (NO in step S206), the controller 22 performs step S201.

### Step S207

The controller 22 causes the speech reproduction unit 23 to start reproducing the received speech data.

### Step S208

The speech reproduction unit 23 reproduces the speech data.

### Step S209

The speech reproduction unit 23 terminates the reproducing of the speech data.

### Embodiment 2

The example of using one server 3 has been described for the embodiment; however, the functions of the server 3 may be implemented by separate servers. In a case where a plurality of servers are used, the servers may be managed by the same operator or different operators.

### Embodiment 3

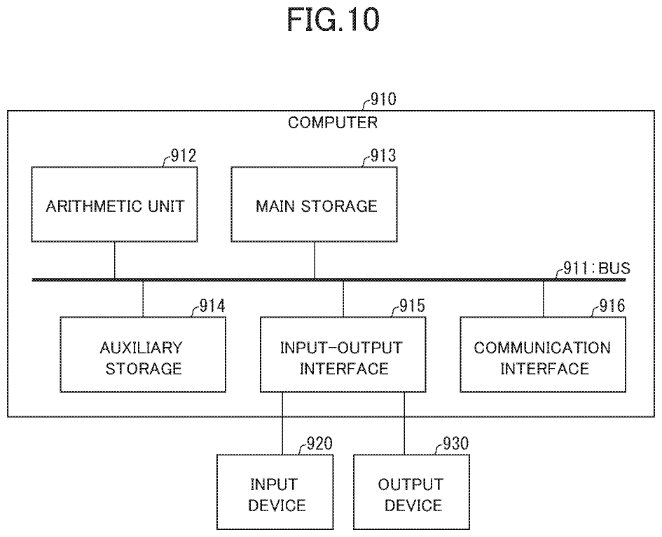

The blocks of the terminals 2 and the server 3 may be implemented by a logic circuit (hardware) formed on an integrated circuit (IC chip) or by software. In the latter case, the terminals 2 and the server 3 may each be configured by using a computer as illustrated in FIG. 10.

FIG. 10 is a block diagram illustrating the configuration of a computer 910 usable as the terminals 2 or the server 3. The computer 910 includes an arithmetic unit 912, a main storage 913, an auxiliary storage 914, an input-output interface 915, and a communication interface 916 that are mutually connected via a bus 911. The arithmetic unit 912, the main storage 913, and the auxiliary storage 914 may be, for example, a processor (such as a CPU), a random access memory (RAM), and a hard disk drive, respectively. To the input-output interface 915, an input device 920 and an output device 930 are connected. The input device 920 is provided for the user to input various pieces of information into the computer 910, and the output device 930 is provided for the computer 910 to output various pieces of information for the user. The input device 920 and the output device 930 may be incorporated into the computer 910 or may be connected (externally attached) to the computer 910. For example, the input device 920 may be a keyboard, a mouse, or a touch sensor, and the output device 930 may be a display, a printer, or a speaker. A device having both of the functions of the input device 920 and the output device 930, such as a touch panel having a touch sensor and a display integrated thereinto, may also be used. The communication interface 916 is an interface for the computer 910 to communicate with an external apparatus.

The auxiliary storage 914 stores therein various programs for operating the computer 910 as the terminal 2 or the server 3. The arithmetic unit 912 loads each of the above-described programs stored in the auxiliary storage 914 into the main storage 913, executes instructions included in the program, and thereby causes the computer 910 to function as a corresponding one of the functions of the terminal 2 or the server 3. It suffices that a recording medium included in the auxiliary storage 914 and storing information such as programs is a computer readable “non-transitory tangible medium”. The recording medium may be, for example, tape, a disc, a card, a semiconductor memory, or a programmable logic circuit. If the computer is capable of running the program recorded in the recording medium without loading the program into the main storage 913, the main storage 913 may be omitted. Note that the above-described devices (the arithmetic unit 912, the main storage 913, the auxiliary storage 914, the input-output interface 915, the communication interface 916, the input device 920, and the output device 930) may each be one device or a plurality of devices.

The above-described program may be acquired from the outside of the computer 910. In this case, the program may be acquired via any transmission medium (such as a communication network or a broadcast wave). The present disclosure may also be implemented in the form of a data signal embedded in the carrier wave and embodied by electronical transmission of the above-described program.

The present disclosure is not limited to the embodiments described above. Various modifications may be made within the scope of claims. An embodiment obtained by appropriately combining technical measures disclosed in different embodiments is also included in the technical scope of the present disclosure. Further, a new technical feature may be created by combining technical measures disclosed in the embodiments.

The present disclosure contains subject matter related to that disclosed in Japanese Priority Patent Application JP 2018-220547 filed in the Japan Patent Office on Nov. 26, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a speech-information acquisition unit; and
a controller,
the controller projecting urgency felt by a user and performing switching of a text of a response to the user based on the projected urgency if speech of the user is acquired via the speech-information acquisition unit while the information processing apparatus or a different apparatus is uttering an utterance text, the urgency being projected based on a start time of the speech of the user.

2. The information processing apparatus according to claim 1,
wherein the controller projects the urgency felt by the user based on a proportion of an amount of a text that is uttered in the utterance text at the start time of the speech of the user to an amount of entirety of the utterance text.

3. The information processing apparatus according to claim 2,
wherein the amount of the text corresponds to a temporal length or the number of characters of the uttered text, and
wherein the amount of the entirety of the utterance text corresponds to a temporal length or the number of characters of the entirety of the utterance text.

4. The information processing apparatus according to claim 1,
wherein the controller
projects the urgency felt by the user based on an amount of a text that is uttered in the utterance text at the start time of the speech of the user.

5. The information processing apparatus according to claim 4,
wherein the amount of the text corresponds to a temporal length or the number of characters of the uttered text.

6. The information processing apparatus according to claim 1,
wherein based on the urgency, the controller performs switching of
a length of a response statement,
an utterance speed, or
the number of response statements
in the text of the response to the user.

7. The information processing apparatus according to claim 6,
wherein the controller
increases the number of response statements in the text of the response to the user if the urgency is low.

8. An information processing method performed by an information processing apparatus, comprising
projecting urgency felt by a user and performing switching of a text of a response to the user based on the projected urgency if speech of the user is acquired while the information processing apparatus or a different apparatus is uttering an utterance text, the urgency being projected based on a start time of the speech of the user.
